(19) United States
(12) Patent Application Publication
(10) Pub. No.: US 2001/0031299 A1
(43) Pub. Date: Oct. 18, 2001

(54) Adsorbent

(76) Inventors: Roland Full, Hosbach (DE); Annelot Krediet, Sailauf (DE); Christian Kilgenstein, Wiesen (DE); Elfriede Sextl, Geiselbach (DE)

Correspondence Address: PILLSBURY WINTHROP LLP, 1600 TYSONS BOULEVARD, MCLEAN, VA, 22102, US

(21) Appl. No.: 09/808,094

(22) Filed: Mar. 15, 2001

(30) Foreign Application Priority Data
Mar. 15, 2000 (EP) 00 105 531.8

(51) Int. Cl. A23B 7/00

(52) U.S. Cl. 426/419; 502/60

(57) ABSTRACT

An adsorbent having a hydrophobic zeolite and at least one binding agent which adsorbent adsorbs traces of volatile and gaseous organic substances from gaseous mixtures so strongly that a concentration of the volatile, organic substance in the gaseous mixture of less than 500 ppm after adsorption, is attained.

### CROSS-REFERENCE TO RELATED APPLICATION

This application claims priority from European Application EP 00105531.8, filed on Mar. 15, 2000, the complete disclosure of which is hereby incorporated herein by reference.

### BACKGROUND OF THE INVENTION

1. Field of Invention

The invention is related to an adsorbent having a hydrophobic zeolite, for adsorbing traces of volatile and gaseous organic substances from gaseous mixtures.

2. Background

Farmers do not, in general, know the biochemical basis for ripening when apples are stored next to potatoes. However, farmers have known that if rot occurs in fruit placed on the fruit shelf, then a gaseous substance is involved, which infects the vicinity like a virus—ethene. It is also described in the literature as “ripeness gas” or “apple gas”. Its effect on plants is complicated, even though it is the simplest phytohormone known from a chemical standpoint. Since it decisively influences fruit ripeness, modem methods of storage and transport attempt to exclude ethene. The expense involved is considerable. The storage temperature has to be lowered to temperatures of 3° C. -4° C. with significant expenditure of energy, the oxygen content is reduced and the CO₂ content is raised and finally ethene is eliminated by catalytic combustion at 250° C. (5, 6). Presently, effective ethene adsorbents are not known. If one acknowledges the worldwide importance of storage of fruit and transportation of fruit products and the number of containers and ships which must be equipped for such purposes at a great expense (5, 6), then one begins to see the significance of a simple ethene filter.

The history of the discovery of the phytohormone ethene goes back to the beginning of the 20^{th} century (Neljubov/1901) (7). Even though it is a simply constructed hydrocarbon, its effects on plants are very complex. It is produced by all higher plants at different synthesis rates and inhibits or advances certain development processes, depending on the state of development of the tissue; sometimes it can even do both, depending on the concentration. Ethene participates in the control of the growth and development processes of higher plants during the entire morphogenesis, starting with the germination of the seed via the ripening of the fruit until senescence, and also influences plant reaction to environmental stimuli (7, 8). Ethene also plays an important part in the ripening of fruits (3).

Investigations have documented that it not only occurs as a byproduct of maturation but also as a governing control substance, especially in climacteric fruits. Climacteric fruit (e.g., apples, pears, tomatoes, bananas) are distinguished from non-climacteric fruits (e.g., strawberries, cherries, citrus fruits) by a sharp rise in the ethene synthesis with a simultaneous climacteric rise in respiration during a certain maturation phase. Unripe climacteric fruits react to an addition of ethene by advancing in the rise in respiration and an earlier ripening of the fruit (2). It is known today that a rise in ethene and fruit ripeness is initiated by slight amounts (0.1 ppm) of ethene in pre-climacteric fruit. Ethene can induce self-synthesis of ethene, in an autocatalytic process, if the fruit is in a sensitive state.

According to McMunhire, two systems regulate the synthesis of ethene in the ripe fruit. System I controls the basic content of ethene, the fruit tissue reacts to the ethene, after a certain degree of development, by the formation of maturation-specific hydrolases that initiate the decomposition of cellular walls. The oligosaccharides released thereby, initiate an autocatalytic synthesis of ethene in system II. The ripening of the fruit tissue is synchronized in that the positive feedback mechanism of the second system, results in a rise of ethene in the cell and on the adjacent cells. The ethene initiates the same reaction in the cells and adjacent cells by binding to specific receptors. It elevates the permeability of membranes, thereby accelerating the metabolism and consequently the ripening of the fruit in this manner. The problem of biosynthesis of ethene is now considered resolved. A brief discussion follows:

L-methionine→S-adenosylmethionine (SAM)→1-aminocyclopropane-1-carboxylic acid (ACC)→ethene.

The actual ethene synthesis begins with the conversion of SAM to ACC, which is catalyzed by enzyme ACC synthase (2).

Ethene can develop its effect not only on a part of the plant far removed from the seat of generation but also in an adjacent specimen (7). It is therefore a hormone as well as a pheromone. However, the pheromone effect is not limited to fruit of the same type but rather also exists between specimens of different types.

A fruit becomes softer and sweeter during the course of its ripening. It changes its color, texture and aroma (7). The process of rot is considered a simple approximation herein for the development of the fruit beyond the state of ripeness and “overripeness”. The fruit is weakened to such an extent by the decomposition processes, such that fungi and bacteria can penetrate and subsequently return the plant parts into organic compounds. Sometimes a distinction is also made between rot and decay. Rot is primarily based on bacterial activity, and is slower in relatively dry conditions. An acidic environment on the other hand favors fungal activity, which is not dependent on high atmospheric moisture(14).

Many fruits can produce a large amount of ethene during a certain ripening phase (climacterium), which causes adjacent, unripe fruits to rapidly ripen. Therefore, in practice, the formation of ethene is blocked either by low temperatures or by removing formed ethene from the storage atmosphere, in an effort to keep the fruits from ripening (during transport, for example) and not stimulate maturity. The fruit is then ripened for sale, by gassing with ethene (5). It is also disadvantageous for the same reason to store late-ripening apples in the same space with early-ripening ones since the late-ripening apples will ripen prematurely.

The ripening of fruit can also be delayed by an inhibitor of ethene synthesis or by storage at reduced atmospheric pressure (2). Essentially, there are two types of storage methods—cold storage and storage in a controlled atmosphere (CA). Customary temperature conditions for cold storage and storage in a controlled atmosphere are from −1° C. to 12° C. at a relative atmospheric moisture content of 80%-90%. Good ventilation conditions are induced by the circulation of air, such as an air wash, in order to remove ethene. In this way, the storage of apples can be extended to 4-8 months and that of pears 2-6 months.

The term “controlled atmosphere” signifies temperatures from 0° C. to 5° C., O₂ concentrations of approximately 3% and CO₂ concentrations of 0-5%. It is important to maintain the optimal conditions for the particular fruit type. All of these measures are necessary because fruits and fruit products take in oxygen after the harvest and emit carbon dioxide, heat, and ripening gases, whose threshold values need to be precisely maintained. The storage times are therefore very closely connected to the ripening processes. Currently, these storage techniques have been successfully used primarily during the transport of tropical fruit in refrigerated ships or refrigerated containers or during the storage of domestic fruit (5, 6).

Unfortunately, a side-effect of storage is that the formation of aroma can be sharply limited in fruit, due to a low content of O₂ and a high content of CO₂ in the storage atmosphere, which negatively influences important taste components (e.g., in apples) (1).

Therefore, if ethene causes the ripening of fruit, modem storage methods must try to exclude ethene from the storage atmosphere and suppress the effect of ethene to delay the fruit from ripening in an effort to extend the keeping quality of the fruit. The present invention describes the use of silver-impregnated Y zeolites as adsorbent for ethene.

### SUMMARY OF THE INVENTION

One embodiment of the present invention is an adsorbent comprising a hydrophobic zeolite and at least one binding agent, wherein the adsorbent strongly adsorbs traces of volatile and gaseous organic compounds from gaseous mixtures, and wherein the concentration of the volatile and gaseous organic compounds in the gaseous mixture is less than 500 ppm after adsorption.

In a preferred embodiment, the hydrophobic factor of the adsorbent is greater than 1. The adsorbent can be a silicon-rich zeolite. Dealuminized Y zeolites and/or ZSM-5 zeolites and/or mordenites can be used as silicon-rich zeolite.

Metal-doped zeolites can be used as adsorbent; the metal doping can consist of one or more noble metals. The noble metal can be present in ionic or elementary form, or mixtures thereof. In particular, silver can be used as noble metal.

### BRIEF DESCRIPTION OF THE DRAWINGS

FIG. 1 is a graphical representation of the adsorption capacities of the individual zeolite types versus ml C₂H₄/g zeolite.

FIG. 2 is a graphical representation of the adsorption capacities of DAY F40 1% by wt. (FD) at different concentrations of ethene versus ml C₂H₄/g zeolite.

FIG. 3 is a graphical representation of the adsorption capacities of DAY F40(FD) 1% by wt. versus ml ethene/g zeolite.

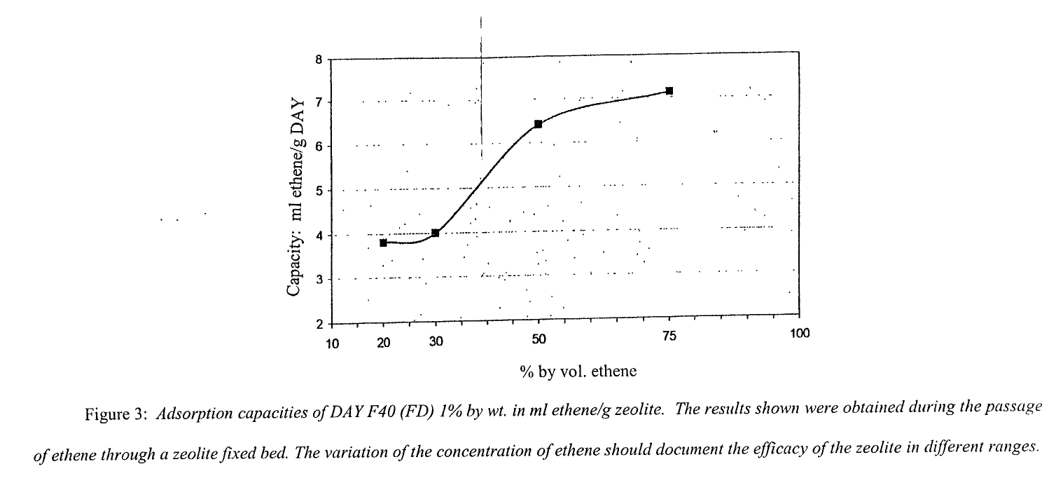

FIG. 4 is a graphical representation of course of time of the adsorption for a defined concentration of ethene versus time, in an Erlenmeyer flask.

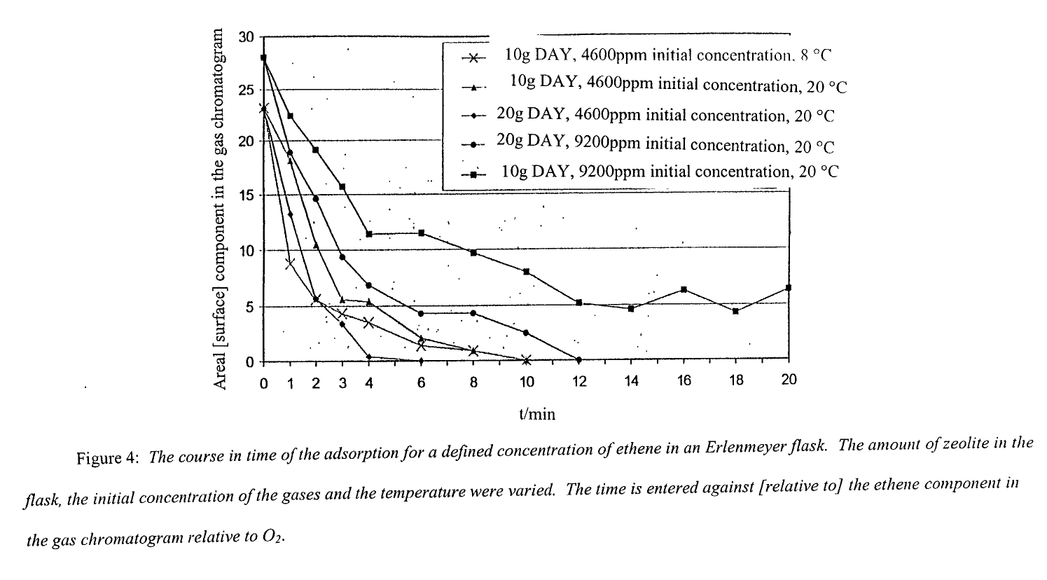

FIG. 5 is a graphical representation of the course of time of the adsorption at low initial concentrations.

FIG. 6 is a graphical representation of the maximum charge over 5 adsorption cycles.

FIG. 7 is a photograph comparing two kiwis after five weeks storage.

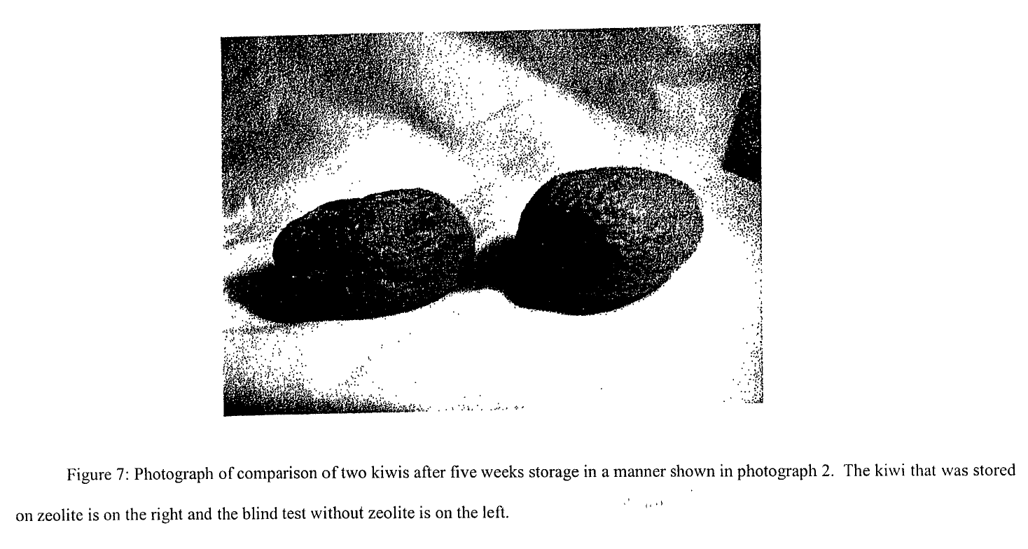

FIG. 8 is a photograph of the test construction for simulating the situation of a food shelf.

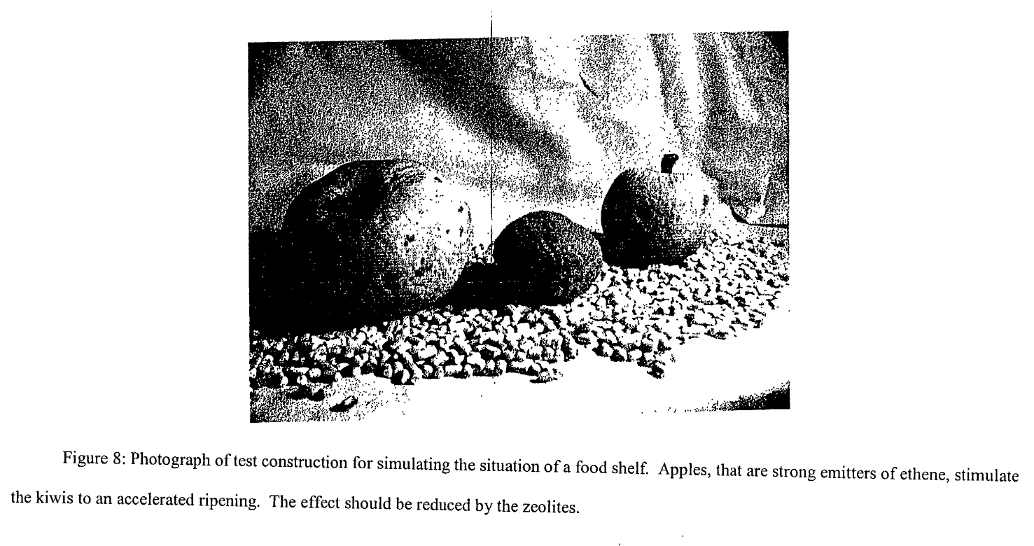

FIG. 9 is a photograph of the test construction for the adsorption of ethene in a flowthrough of ethene.

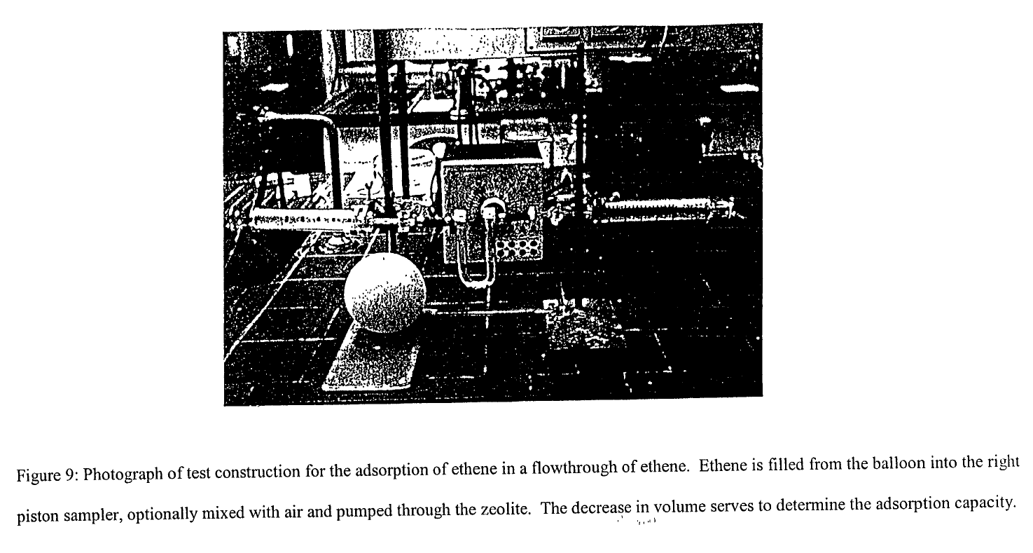

FIG. 10 is a photograph of the “burette test”

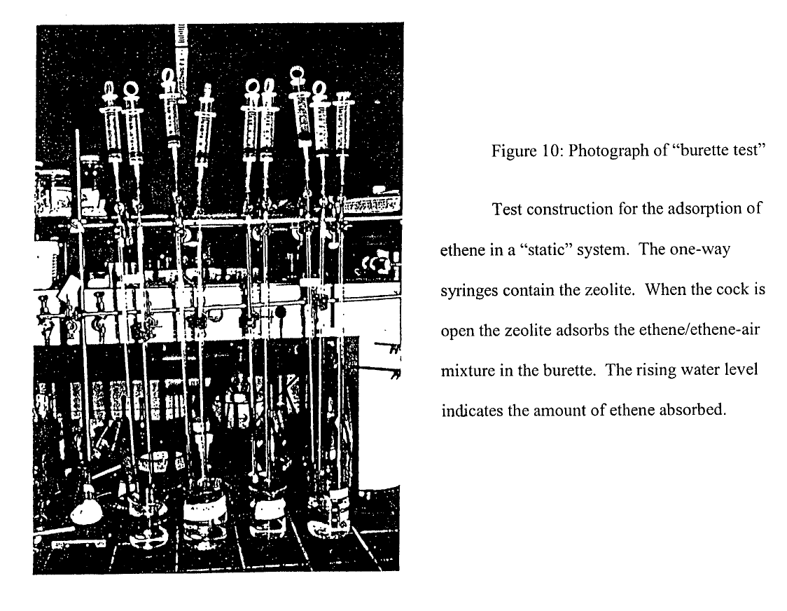

FIG. 11 is a photograph of the test construction in order to detect the acceleration of ripening by “infection”.

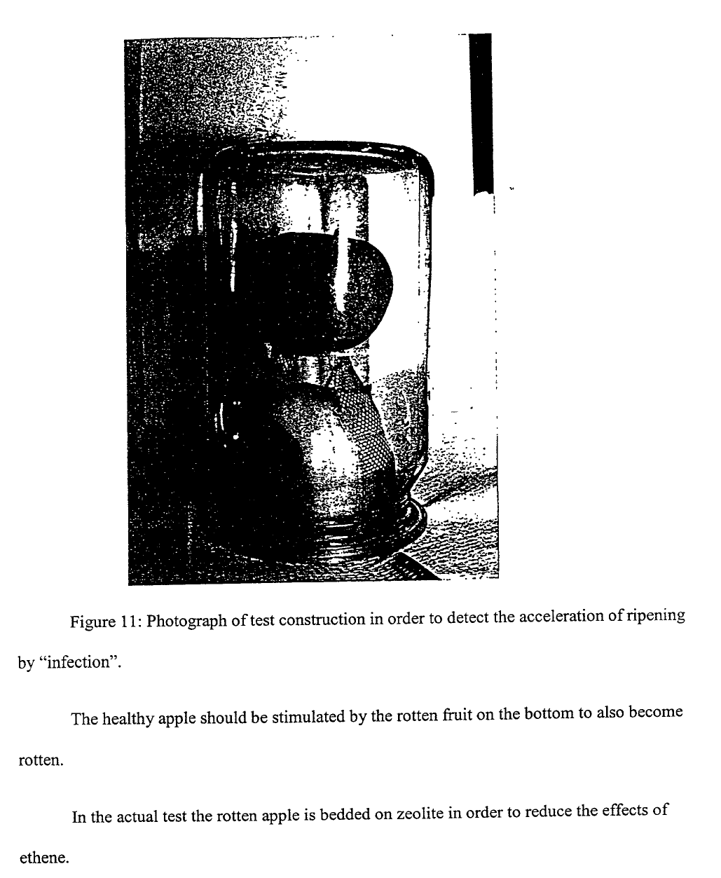

### DESCRIPTION OF PREFERRED EMBODIMENTS

The present invention describes use of adsorbent to reduce the content of volatile organic substances from less than/equal to 5000 ppm or 10,000 ppm to values below 500 ppm, preferably below 100 ppm. The concentration can be reduced from an initial concentration of less than/equal to 1000 ppm to below 10 ppm. The volatile, organic substances can have boiling points below 200° C., below 50° C. and below 0° C. The adsorbent in accordance with the invention can be used preferably for the adsorption of ethene.

In a further preferred embodiment of the invention, the adsorption of volatile, organic compounds can take place from a gaseous mixture of air, enriched, if necessary, with nitrogen and/or carbon dioxide.

Only hydrophobic zeolites were considered for our investigations. The two hydrophobic zeolites used were the Wessalith DAY® and DAZ® types, which are manufactured by Degussa-Hüls. The zeolites are characterized, based on their crystalline structure, as alumosilicates. They are very porous but have an advantage over activated carbon in defining pore diameter. The ratio of silicon to aluminum, the modulus, in the Y zeolite (Dealuminized Y zeolite is “DAY” hereinafter) is changed by special manufacturing methods in favor of the silicon. The ratio is 200:1 in the DAY. The zeolites loose their ionic components due to dealuminization and as a consequence obtain a hydrophobic character. In addition, the DAY zeolite has a pore size of 0.8 nm, which also makes possible for the adsorption of large molecules. Thus, the DAY zeolite becomes the ideal adsorbent for hydrocarbons of all types. Many other uses can be found for the zeolite, including the purification of exhaust air to eliminate odor problems.

The DAZ is a dealuminized zeolite of the ZSM5 type (hereinafter “DAZ”). It comprises two different pore systems with diameters in the range of 7 Å. The excellent adsorption qualities are also related to a large inner surface of 800 m²/g and the micropore volume of 0.3 cm³/g (3).

Various extrudates were studied, as shown in Table 1. They are produced with a binding-agent component of approximately 10%.

TABLE 1
List of zeolites used

| Zeolite | Trade name | Description |
|---|---|---|
| DAY | F20 | DAY zeolite, pressing cylinder Ø 2 mm |
| | F40 | DAY zeolite, pressing cylinder Ø 4 mm |
| | | (only solid-doped 1% by weight) |
| | 56/92 | DAY zeolite, pressing cylinder Ø mm × 9 mm |
| | HK | DAY zeolite, hollow body Ø 8 mm × 12 mm |
| DAZ | F20 | DAY zeolite, pressing cylinder Ø 2 mm |
| | F40 | DAY zeolite, pressing cylinder Ø 4 mm |
| | HK | DAY zeolite, hollow body Ø 8 mm × 12 mm |

The rationale for the improvement in adsorption capacity by silver is now outlined. It has been known since the middle of the 19^{th} century that noble metals can “bind” unsaturated hydrocarbons. In 1830, the Danish pharmacist Zeise described a compound with the composition PtCl₂ (C₂H₄), in which an ethene molecule is bound to a platinum ion (10). Obviously, noble metals have a certain affinity with their free d orbitals for small, organic molecules with electron donor function, conditioned by high electron densities along the double bonds.

We selected two methods for doping with silver:

1. Doping with AgNO₃ solution (solution doping)

2. Doping by admixing crystalline AgNO₃ during the production process (solid doping).

In order to fix the silver in the zeolite, a calcination is carried out at 850° C. The emission of nitrous gases indicates the breakdown of the nitration. Even zeolite experts are not definitively able to explain the form of the silver present after the calcination specifically, whether the silver is in the elementary form (a reduction would be necessary for that) or in its ionic form, as Ag⁺ in the +1 oxidation stage.

According to the invention, commercial DAY zeolites with a solid doping of 1% by wt. silver were used. In order to obtain solution doping, the zeolite material is allowed to stand overnight in a solution of silver nitrate with a certain concentration, then dried for two hours at 80° C. in a drying oven and subsequently calcined. We doped all zeolite molded bodies with 1%, 3% and 5% silver nitrate solution. The hollow bodies were doped with 3% solution.

It is important to sort the zeolites according to their suitability for the adsorption of ethene. One criterion is the adsorption capacity that describes the maximum charge. Starting from very simple means, we developed a method that could be described in the broadest sense as “volumetric gas analysis”.

### EXAMPLE 1

An inverted 50 ml burette functions as a calibrated gas collector tube. A beaker containing water is placed at the mouth of the burette and a 50 ml one-way syringe containing the adsorbent, is connected to the top outlet tip of the burette, via a section of vacuum hose. The burette can filled very readily, in accordance with the pneumatic principle, with defined amounts of pure gas or of a gaseous mixture.

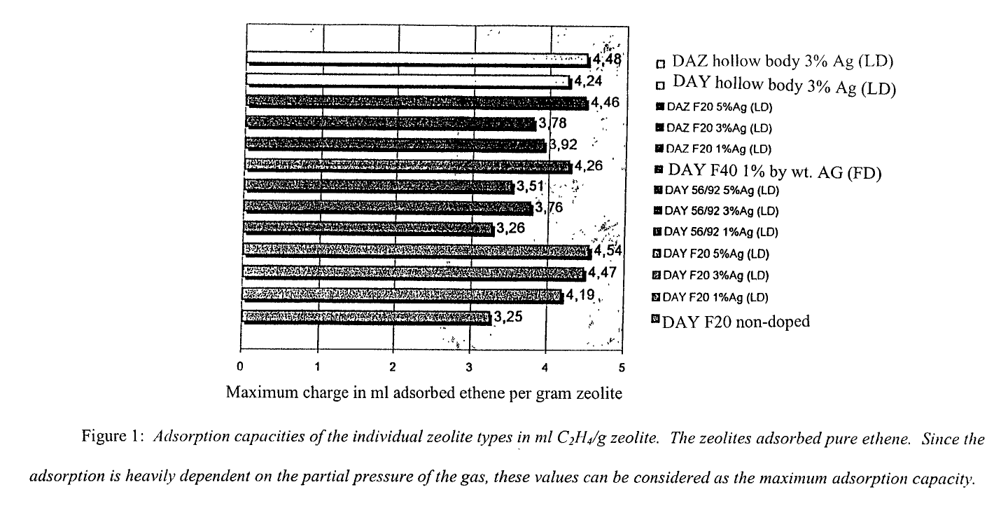

The gas contacts the adsorbent upon the opening of the burette cock. The water column rising in the burette indicates the amount of adsorbed gas. Several tests were started in parallel and blind tests were included as reference test. Since the cock and the opening in the burette tip have only a small diameter, it takes two days until a constant final value is adjusted to indicate the maximum adsorption of ethene under the particular conditions. The findings presented in FIG. 1 show that a silver doping in the adsorbent actually significantly elevates the adsorption capacity, in contrast to the non-doped material as adsorbent. In a direct comparison of undoped DAY F20 to DAY F20 with 1% solution doping, the adsorption in the case of the silver DAY was approximately 25% better than undoped DAY F20. No differences in adsorption resulted between adsorbent DAY F40 with solution doping and solid doping (1%). In the case of the DAY F20, the adsorption capacity does rise as the doping amount increases. However, the rise is not striking in a zeolite doped between 3 and 5 percent. Similar results are obtained for the DAZ F20. In the case of the zeolite DAY 56/92, a deterioration can be detected at too high a doping amount.

The size and the surface of the molded bodies apparently influence the adsorption qualities: DAY 56/92, with large, cylindrical molded bodies, is significantly worse in performance than the small-cylindrical F20 molded bodies.

A comparison between DAY zeolites shows only marginal differences. Since the solution doping is very labor-intensive for rather large charges and solid-doped F40 cylinders achieved maximum values, zeolites already doped were used as working examples. The adsorption as such is based on comparatively weak forces occurring between the adsorber surface and the adsorbate. The equilibrium between adsorption and desorption is heavily dependent on the concentrations and the partial pressures of the gases to be absorbed.

### EXAMPLE 2

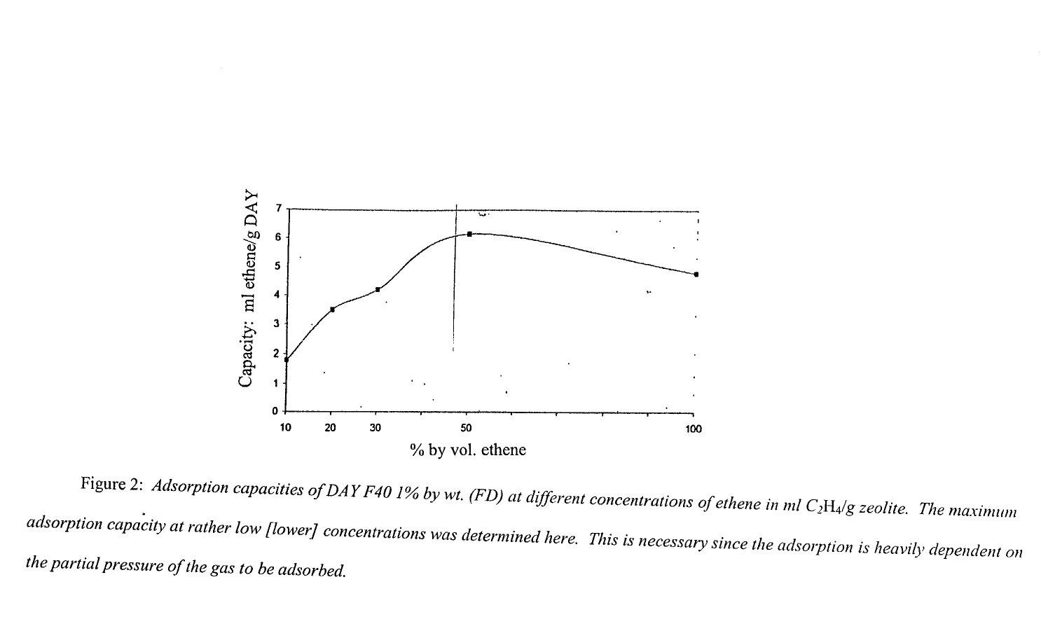

The burette test was used to determine the adsorption capacity of the silver DAY as applied to low concentrations of ethene. We lowered the ethene content in the mixture by admixing air and filled the burettes therewith. Since the amount of ethene in the burettes relative to the zeolite had now been lowered, it was also necessary to reduce the amount of zeolite. FIG. 2 contains a presentation of the values determined in this manner. The zeolite is still capable, even at a concentration of 10% by volume ethene, of adsorbing 1.8 mm per gram. The apparent maximum is achieved at 50% by volume of ethene. In the tests described above, diffusion flow insures contact between the two partners, ethene and adsorbent. Thus, adsorption is a static phenomenon in this experiment.

### EXAMPLE 3

In order to gain insight into the adsorption processes in a dynamic test, further tests were conducted in which ethene was pumped over [via] a zeolite fixed bed. We used a U-tube with fixed-bed filling. Two flask samplers were connected laterally to the end of the U-tube.

If a defined volume of ethene or a defined ethene-air mixture is drawn into a flask sampler, the decrease in volume after passing over the zeolite filter can be read directly on the scale of the flask sampler by simply pumping the gas back and forth. The kinetic energy of the air flowing through also counteracts the adsorption of ethene in a dynamic process, in addition to the thermal motion of the particles and the concentration gradient of the equilibrium. Therefore, it was logical to determine the adsorption capacities for different ethene concentrations under dynamic conditions, and to compare them with the results in the “static” burette test, listed above. The high adsorption capacity at 75% by volume initial concentration of ethene is remarkable. The differences between both systems are marginal in the further course of the curve. Consequently, no disadvantageous influencing of the adsorption capacity would occur during the flow-through in a practical application.

### EXAMPLE 4

In order to obtain insight into adsorption and its dependence on time, the following test was conducted: A closed Erlenmeyer flask of a known volume with a lateral port was filled with zeolite. Ethene was injected through a pinched-off rubber hose connected to the lateral port. A gas specimen was removed at fixed intervals after the injection of ethene, and an image of the adsorption course versus time was plotted based gas-chromatogram analysis. In separate laboratory tests, the amount of zeolite in the flask, the temperature and the initial concentration of ethene were varied.

If a rather large amount of silver doped DAY was used, the adsorption rate was only slightly higher. However, the larger amount of zeolite distinctly lowers the final concentration of ethene. No deterioration of the adsorption behavior occurs in low temperature ranges, such as those occurring in refrigerated containers. However, the adjustment of equilibrium seems to take place at approximately the same time. Consequently, the adsorption rate is not significantly influenced, but the equilibrium concentration can be influenced by changes in temperature. We carried out the tests in the 1 ml-10 ml scale, relative to the dosing of ethene, that is, in a concentration range of 1000 ppm-10000 ppm. However, it is apparent from the professional literature that the sensitivity of fruit is in a range of a few ppm, in some instances even below 1 ppm.

### EXAMPLE 5

Before measurement could begin, it was necessary to check whether “wall effects” on the inside of the flask had resulted in a decrease of concentration. This was found not to be the case.

The receptacle was charged with 10 g of silver DAY, sealed and then injected with 1000 μl ethene (approximately 920 ppm). Specimens were removed at two-minute intervals and quantitatively evaluated in a gas chromatogram.

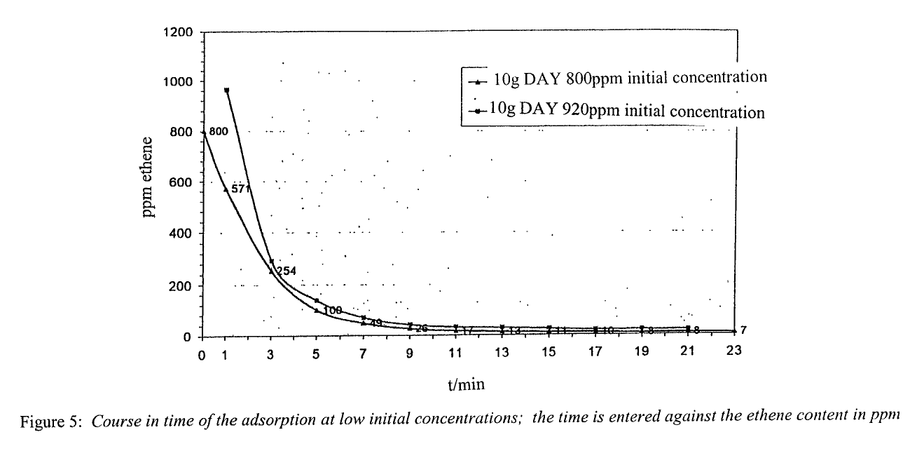

The result was surprising (see FIG. 5). Even given such high degrees of dilution and a “static” adsorber bed that permits an adsorption of gas only via diffusion processes, the concentration of ethene drops rapidly in an extremely short time and is adjusted after 10-20 minutes at 25 ppm and after 30 minutes at approximately 7 ppm. This assures that the adsorber is serviceable in the ethene concentration range, relevant for the ripeness of the fruit. In modem storage halls, the concentrations are approximately 100 ppm of gas, based on other improvements. The zeolite lowers the gas concentration even lower than the previous state of the art.

### EXAMPLE 6

It was important to test for the efficaciousness of zeolite for long-term use during the storage of fruit for economical reasons, and to check zeolite's capacity for regeneration. We used two methods for desorption:

1. Desorption by elevation of temperature

2. Desorption in an air current.

The total desorption took place in a pre-heated drying oven by heating the zeolite specimen at 60° C. for 30 minutes. For the desorption in a current of air, we used a U-tube through which approximately 240 l air/h were drawn after connection of a water-jet pump. The air exiting from the U-tube was examined at certain time intervals with gas chromatography for ethene components.

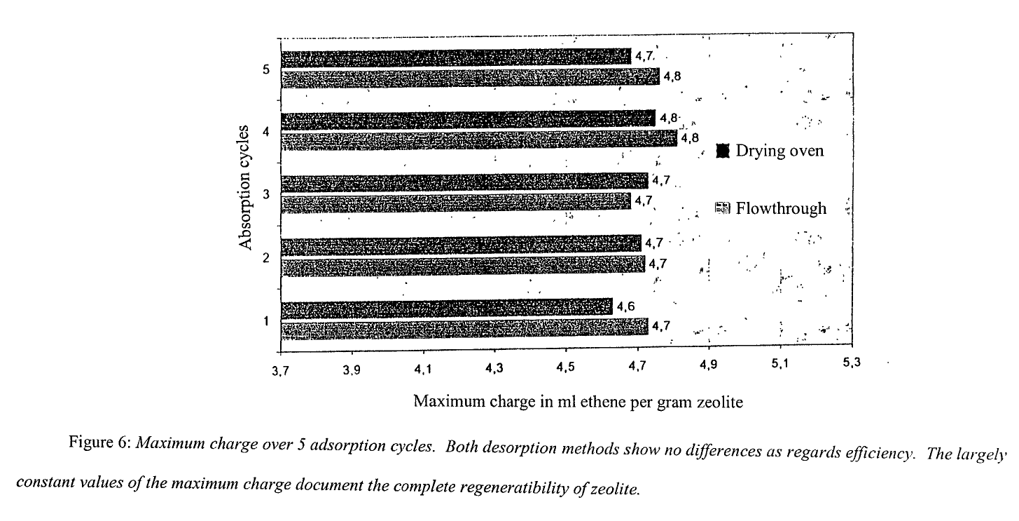

The results were surprising. We reached the detection limit of our gas chromatograph in the air current after only 12 minutes. That is, the ethene concentration of the air dropped in this time period to below 750 ppm. This “discharge” can be clearly accelerated if ambient air of 60° C. is used for the desorption. On the other hand, a lowering of the flowthrough of air diminishes the desorption strongly, such that the detection limit is not reached until after an hour. Both methods assure a complete discharge of the zeolite (see FIG. 6). Zeolite specimens were tested here over five charging cycles with regard to their maximum charge. No “tiring” of the adsorber could be determined. The efficiency of both desorption methods appears to be comparable.

### EXAMPLE 7

The practical application of the use of adsorbent was quite significant. Fruit and fruit products were tested in this stage of the operation. The analyzing device used was a purely visual check. Therefore, in order to simulate the situation of a fruit shelf, we placed two apples in the direct vicinity of various fruits on a zeolite bed. Ripe apples are strong emitters of ethene. An accelerated ripening was demonstrated in the reference test without zeolite. Such experiments are sufficiently known in the literature and have also been disclosed for experimental biological instruction. No effects could be observed with bananas and potatoes. However, kiwis, which react very sensitively to ethene, displayed the first differences after three weeks of exposure to ethene. The fruits in the reference test were distinctly softer and were wrinkled. The same effect also occurred in the combination kiwi/zeolite, but with a delay of one week. The reference kiwi ripened more rapidly. The zeolite obviously had a similar effect, even though it was slight.

### EXAMPLE 8

The effect of endogenically produced ethene which becomes retroactively stronger as it accumulates around the fruit in a closed system. To this end, fruit was enclosed in an airtight manner in preservation bottles and observed for differences in appearance in the ripening behavior if the bottle was additionally charged with silver (DAY). However, no changes occurred in the observed time period of six weeks. It is assumed that the fruit had converted the oxygen of the receptacle for a brief time period and as a consequence of the lack of oxygen the fruit was not able to gain sufficient energy necessary for ripening. A gas chromatogram prepared at the end of the test confirmed the results with a large amount of CO₂ being found, but almost no oxygen.

### EXAMPLE 9

Based on the above experiment, an apparatus was designed to work in a largely closed system. Inverted 1.5 l preservation bottles were prepared in such a manner that a rotten apple lay on the bottom on a zeolite bed. A healthy apple resting on a wire net was located over it. Air could still penetrate through a narrow slot between the glass and the support, thus making sufficient oxygen available for respiration. The infection was supposed to start from the rotten apple on the bottom and affect the healthy one on the wire grid.

The present invention of silver-doped DAY zeolite is an attractive alternative compared to the traditional methods used to remove ethene from the atmosphere in order to keep fruit fresh. The adsorption capacity is remarkably high, probably higher than that of activated carbon. The zeolite filters of the invention should be able to be used for a very long time in that manner. The desorption that follows is simple and inexpensive. We previously knew that the low temperature in cold storage does not constitute a negative influence. The adsorption capacity is generally very temperature-dependent. Since even slight traces of ethene show their effects in controlled-atmosphere (CA) storage, it is significant that DAY can lower the ethene content to a few ppm.

### Bibliography

1) A. Brackmann, J. Streif and F. Bangerth: Einfluss von CA-beziehungsweise ULO-Lagerbedingungen auf Fruchtqualität and Reife bei präclimacterisch und klimakterisch geernteten Äpfeln [German: Influence of CA and ULO Storage Conditions on Fruit Quality and Ripeness in Apples Harvested Pre-Climacterically and Climacterically], in: Gartenbauwissenschaft 1/95

2) G. Bufler: Die Regulation der Ethylensynthese von Äpfeln während der Fruchtreife and Lagerung [German—The Regulation of the Ethylene Synthesis of Apples during the Maturation and Storage of Fruit], in: Erwerbsobstbau 6/86, pp. 164-166

3) S. -J. Choi; G. Bufler; F. Bangerth: Ethylensensitivität von Apfel- und Tomatenfrüchten während ihrer Entwicklung [German—Ethylene Sensitivity of Apples and Tomatoes During Their Development], in: Gartenbauwissenschaft 4/94, pp. 154-158

4) Degussa AG: Wessalith® DAY, A Hydrophobic Adsorbent for Gas Purification; Technical Information No. 4307.1, July 1991

5) K. -H. Hochhaus; Y. Wild: Kühlcontainer mit kontrollierter Atmosphäre [German—Refrigerated Container with Controlled Atmosphere]; in: Schiff & Hafen/Seewirtschaft, 4/92, pp. 41-46

6) K. -H. Hochhaus: Energetische Optimierung von Ladungskühlanlagen mit kontrollierter Atmosphäre [German—Energetic Optimization of Cargo Refrigerating Systems with Controlled Atmosphere]; in: Jahrbuch der Schiffbautechnischen Gesellschaft 1987, pp. 375-384

7) Sabine Koch: Steuerung pflanzlicher Alterungsprozesse durch Ethen [German—Control of Plant Ageing Processes by Ethene] in: Sekundarstufe II, Sept. 1997

8) Klaus Lürssen: Das Pflanzenhormon Ethylen [German—the Plant Hormone Ethylene]; in: Chemie in unserer Zeit, 4/81, pp. 122-128

9) Lothar Puppe: Zeolithe—Eigenschaften und technische Anwendungen [German—Zeolites—Properties and Industrial Applications], in: Chemie in unserer Zeit 4/1986, pp. 117-127

10) Römps Chemielexikon

11) Miriam Sachs: Die Speicherung von Ethen in DAY-Zeolithen [German—The Storage of Ethene in DAY Zeolites]; professional article in Fach Chemie [can not tell if this is a journal; if not, the phrase reads “prof. article in the chemical field”], Hösbach, Feb. 1997

12) Arno Tissler; Ulrich Müller; Klaus K. Unger: Synthetische Zeolithe und Alumophosphate [German—Synthetic Zeolites and Aluminophosphates], in: Nachrichten chemisch technisches Labor, 6/1988

13) www.rrz.uni-hamburg.de/biologie/b_online/d31/31.htm

14) www.merian.fr.bw.schule.de/Beck/skripten/12bs12-51.htm

15) Ziegler: Physiologie [German—Physiology], place of publication and year unknown, p. 368

16) Ziegler: Physiologie [German—Physiology], place of publication and year unknown, pp. 389-390

1. An adsorbent comprising a hydrophobic zeolite and at least one binding agent, wherein the adsorbent strongly adsorbs traces of volatile and gaseous organic compounds from gaseous mixtures, and wherein concentration of the volatile and gaseous organic compounds in the gaseous mixture is less than 500 ppm after adsorption.

2. The adsorbent according to claim 1, wherein the adsorbent has a hydrophobic factor greater than 1.

3. The adsorbent according to claim 2, wherein the adsorbent is silicon-rich zeolites.

4. The adsorbent according to claim 3, wherein the silicon-rich zeolites are selected from a group consisting of dealuminized Y zeolites, ZSM-5 zeolites, mordenites and mixtures thereof.

5. The absorbent according to claim 1, wherein the adsorbent is metal-doped zeolites.

6. The adsorbent according to claim 5, wherein the metal doped zeolite comprises a noble metal or a mixture thereof.

7. The adsorbent according to claim 6, wherein noble metal is in ionic form, elementary form or combinations thereof.

8. The adsorbent according to claim 6, wherein the noble metal is silver.

9. The adsorbent according to claim 1, wherein concentration of the volatile and gaseous organic compounds in the gaseous mixtures is reduced from a concentration of less than or equal to 10,000 ppm to values below 500 ppm after adsorption.

10. The adsorbent according to claim 9, wherein concentration of the volatile and gaseous organic compounds in the gaseous mixtures is reduced from a concentration of less than or equal to 10,000 ppm to values below 100 ppm after adsorption.

11. The adsorbent according to claim 1, wherein concentration of the volatile and gaseous organic compounds in the gaseous mixtures is reduced from a concentration of less than or equal to 5,000 ppm to values below 500 ppm after adsorption.

12. The adsorbent according to claim 11, wherein concentration of the volatile and gaseous organic compounds in the gaseous mixtures is reduced from a concentration of less than or equal to 5,000 ppm to values below 100 ppm after adsorption.

13. The adsorbent according to claim 1, wherein concentration of the volatile and gaseous organic compounds in the gaseous mixtures is reduced from a concentration of less than or equal to 1,000 ppm to values below 100 ppm after adsorption.

14. The adsorbent according to claim 13, wherein concentration of the volatile and gaseous organic compounds in the gaseous mixtures is reduced from a concentration of less than or equal to 1,000 ppm to values below 10 ppm after adsorption.

15. The adsorbent according to claim 1, wherein the volatile and gaseous organic compound has a boiling point below 200° C.

16. The adsorbent according to claim 15, wherein the volatile and gaseous organic compound has a boiling point below 100° C.

17. The adsorbent according to claim 16, wherein the volatile and gaseous organic compound has a boiling point below 50° C.

18. The adsorbent according to claim 17, wherein the volatile and gaseous organic compound has a boiling point below 0° C.

19. The adsorbent according to claim 1, wherein the volatile and gaseous organic compound is ethene.

20. The adsorbent according to claim 1, wherein the gaseous mixture is air.

21. The adsorbent according to claim 1, wherein the gaseous mixture is enriched with nitrogen relative to that found in air.

22. The adsorbent according to claim 20, wherein the gaseous mixture is enriched with carbon dioxide relative to that found in air.

23. A method for retarding ripening of fruit or vegetable comprising:
placing a fruit or vegetable and an adsorbent comprising a hydrophobic zeolite and at least one binding agent in proximity so that traces of volatile and gaseous organic compounds are adsorbed by the adsorbent,
wherein the concentration of the volatile and gaseous organic compounds in the gaseous mixture is less than 500 ppm after adsorption.

24. A method according to claim 23 wherein the adsorbent has a hydrophobic factor greater than 1.

25. A method according to claim 23 wherein the adsorbent is silicon-rich zeolites.

26. A method according to claim 23 wherein the adsorbent is metal-doped zeolite.

27. A method according to claim 26 wherein the metal-doped noble metal comprises silver.

28. A filter comprising a hydrophobic zeolite and at least one binding agent, wherein the adsorbent adsorbs traces of volatile and gaseous organic compounds from gaseous mixtures, and wherein concentration of the volatile and gaseous organic compounds in the gaseous mixture is less than 500 ppm after adsorption.

29. A filter according to claim 28 wherein the adsorbent has a hydrophobic factor greater than 1.

30. A filter according to claim 28 wherein the adsorbent is silicon-rich zeolites.

31. A filter according to claim 28 wherein the adsorbent is metal-doped zeolite.

32. A filter according to claim 28 wherein the metal-doped noble metal comprises silver.
